(19) United States
(12) Patent Application Publication
(10) Pub. No.: US 2005/0268450 A1
(43) Pub. Date: Dec. 8, 2005

(54) Method of manufacture for air conditioning register box

(76) Inventor: Lester Young, Henderson, NV (US)

Correspondence Address: WEISS & MOY PC, 4204 NORTH BROWN AVENUE, SCOTTSDALE, AZ, 85251, US

(21) Appl. No.: 10/859,950

(22) Filed: Jun. 4, 2004

(51) Int. Cl. B23P 17/00; B23P 19/00

(52) U.S. Cl. 29/412; 29/417

(57) ABSTRACT

A method of manufacture for a register box utilized in an air conditioning system. The method utilizes a sheet of material interposed between a press and, in succession, two surfaces of a progressive die. In a first stamping step, an elongated sheet of material is cut so that a first side having two aligned side cuts is partially formed, a second side opposite the first side is formed, and an opening is created therebetween. In a second stamping step, the first side is fully cut, a flange is created about the opening, and two sections of the material are bent at 90 degree angles so that the first and second sides become substantially U-shaped. Creation of the box is completed through the attachment of a collar to the flange and the attachment of end pieces to the first and second sides.

### FIELD OF THE INVENTION

This invention relates generally to air conditioning systems and, more particularly, to a method of manufacture for the register box component of an air conditioning system.

### BACKGROUND OF THE INVENTION

In a typical air conditioning system, duct work brings cooled air to individual rooms within a structure. At the terminus of a section of duct within a room, a register box is affixed. A register is then affixed to the register box.

Presently, the method for manufacturing a register box consists of multiple steps and is relatively complicated. The present invention is directed to a method of manufacture for a register box wherein the process is simplified and the number of steps is reduced.

### SUMMARY OF THE INVENTION

In accordance with one embodiment of the present invention, a method of manufacture for a register box is disclosed. The method of manufacture comprises the steps of: providing a press; providing a progressive die having a first surface and a second surface; providing an elongated sheet of material; positioning a portion of the elongated sheet of material proximate the first surface and within the press; stamping the press onto the sheet of material proximate the first surface; wherein the stamping proximate the first surface causes formation of two aligned side cuts along a first side of a register box that is being formed from the sheet of material, a second side opposite the first side, and an opening disposed substantially in a middle of the register box that is being formed from the sheet of material; positioning the sheet of material proximate the second surface and within the press; stamping the press onto the sheet of material proximate the second surface; wherein the stamping proximate the second surface causes formation of a cut extending between the two aligned side cuts so as to complete formation of the first side of the register box, forms a flange about the opening, and bends two portions of the sheet of material at right angles relative to a portion of the sheet of material wherein the opening is located so that each of the first side and the second side having a substantially U-shape; attaching a first end piece to the first side; attaching a second end piece to the second side; and attaching a collar to the flange.

In accordance with another embodiment of the present invention, a method of manufacture for a register box is disclosed. The method of manufacture comprises the steps of: providing a press; providing a progressive die having a first surface and a second surface; providing an elongated sheet of material; wherein the sheet of material has a width of about 12″; positioning a portion of the elongated sheet of material proximate the first surface and within the press; stamping the press onto the sheet of material proximate the first surface; wherein the stamping proximate the first surface causes formation of two aligned side cuts along a first side of a register box that is being formed from the sheet of material, a second side opposite the first side, and an opening disposed substantially in a middle of the register box that is being formed from the sheet of material; positioning the sheet of material proximate the second surface and within the press; stamping the press onto the sheet of material proximate the second surface; wherein the stamping proxiamte the second surface causes formation of a cut extending between the two aligned side cuts so as to complete formation of the first side of the register box, forms a flange about the opening, and bends two portions of the sheet of material at right angles relative to a portion of the sheet of material wherein the opening is located so that each of the first side and the second side having a substantially U-shape; wherein the flange has a height of about 0.5″; attaching a first end piece to the first side; attaching a second end piece to the second side; and attaching a collar to the flange; wherein the collar has a height of about 3.5″.

### BRIEF DESCRIPTION OF THE DRAWINGS

FIG. 1 is a perspective view illustrating a step in a method consistent with the present invention, showing a press and a blank sheet of material prior to a first stamp by a press.

FIG. 2 is a perspective view showing the sheet of material of FIG. 1 after a first stamp of the press.

FIG. 3 is a perspective view showing the further transition of the sheet of material following a second stamp of a press.

FIG. 4 is a perspective view illustrating final steps in a method of manufacture of a register box consistent with an embodiment of the present invention.

### DETAILED DESCRIPTION OF THE PREFERRED EMBODIMENTS

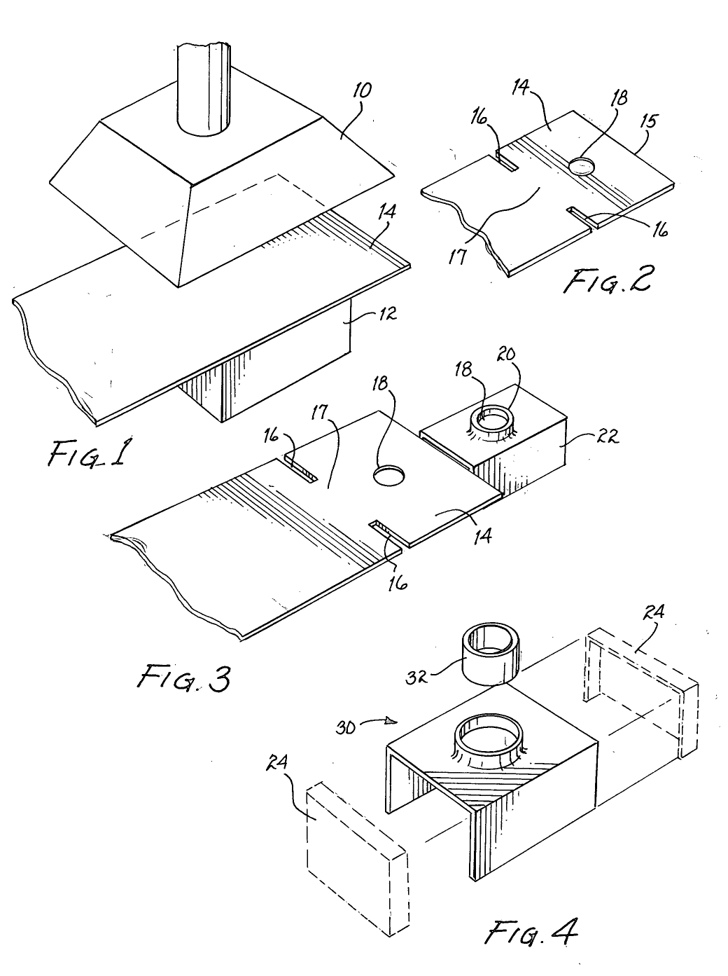

Referring first to FIG. 1, it can be seen that the methods of manufacture of a register box as described herein utilizes a press 10 and die 12, acting on an elongated sheet of metal 14. The die 12 is progressive, so that a single die may perform the steps herein described. It should be clearly understood that FIG. 1 is meant to illustrate the positioning of a material 14 on a press 10 having a die 12, and that departures from the system shown in FIG. 1 are within the spirit and scope of the present invention. For example, the die 12 may be permanently or removably installed on a portion of a press 10, rather than serving as the bottom portion of a press as illustrated in FIG. 1. In addition, the die 12 may be positioned on either or both sides of the sheet of material 14 and may be of any desirable shape and size, and the press 10 may be arranged so that the sheet of material 14 is positioned substantially vertically or at any desirable orientation, as long as the press 10 and die 12 are capable of operating on the material 14 in conformity with the present invention described herein.

Turning now to FIG. 2, the method begins with a first stamping of the press 10 That stamp makes two aligned side cuts 16 and creates opening 18 in the sheet 14. (The side cuts 16 leave an uncut section 17 therebetween, so that it will be possible to advance the sheet 14 for the second cutting step.) The first stamp also cuts the sheet 14 to length along edge 15. A first surface of the progressive die 12 should be configured so that the stamping action of the press 10 yields the result shown in FIG. 1.

Turning now to FIG. 3, a second stamping of the press 10 is illustrated. In this stamping step, a second surface of the progressive die 12 is utilized. (Preferably, the progressive die 12 is configured so that the sheet 14 is moved forward for the second stamp.) This second stamp completes the cut between aligned side cuts 16, creates a flange 20 about opening 18, and folds down at a 90 degree angle sides 22.

One benefit of the method of the present invention is that an enlongated sheet of material 14 may be continuously fed into the press 10 with each stamping so that the first flanged, U-shaped portion of a box is completed in two stampings, and each subsequent stamping completes another U-shaped portion.

Referring now to FIG. 4, the conclusion of the manufacturing method is illustrated. Here, end pieces 24 are attached, preferably by spot-welding, to the open sides of the register box 30 that is being formed. Additionally, a collar 32 is attached to flange 20, again preferably by spot-welding.

The dimensions of the register box 30 and its component portions as herein described may be varied as desired. For many installations, for example, it will be desired to provide a collar 32 having a height of approximately 3.5″. The height of the flange 20 will, in this embodiment, be about 0.5″. The width of the sheet of material, in this example, should be approximately 12″. However, by varying these dimensions, any desired register box 30 can be created.

While the invention has been particularly shown and described with reference to preferred embodiments thereof, it will be understood by those skilled in the art that the foregoing and other changes in form and details may be made therein without departing from the spirit and scope of the invention.

1. A method of manufacture for a register box comprising the steps of:
providing a press;
providing a progressive die having a first surface and a second surface;
providing an elongated sheet of material;
positioning a portion of said elongated sheet of material proximate said first surface and said press;
stamping said press onto said sheet of material proximate said first surface;
wherein said stamping proximate said first surface causes formation of two aligned side cuts along a first side of a register box that is being formed from said sheet of material, a second side opposite said first side, and an opening disposed substantially in a middle of said register box that is being formed from said sheet of material;
positioning said sheet of material proximate said second surface and within said press;
stamping said press onto said sheet of material proximate said second surface;
wherein said stamping proximate said second surface causes formation of a cut extending between said two aligned side cuts so as to complete formation of said first side of said register box, forms a flange about said opening, and bends two portions of said sheet of material at right angles relative to a portion of said sheet of material wherein said opening is located so that each of said first side and said second side having a substantially U-shape.

2. The method of claim 1, further comprising the steps of:
attaching a first end piece to said first side;
attaching a second end piece to said second side; and
attaching a collar to said flange.

3. The method of claim 2 wherein said flange has a height of about 0.5″.

4. The method of claim 2 wherein said collar has a height of about 3.5″.

5. The method of claim 1 wherein said sheet of material has a width of about 12″.

6. The method of claim 1 wherein said first surface and said second surface are aligned with one another, so that said sheet of material may be advanced from said first surface to said second surface by forward movement of said sheet of material.

7. A method of manufacture for a register box comprising the steps of:
providing a press;
providing a progressive die having a first surface and a second surface;
providing an elongated sheet of material;
wherein said sheet of material has a width of about 12″;
positioning a portion of said elongated sheet of material proximate said first surface and within said press;
stamping said press onto said sheet of material proximate said first surface;
wherein said stamping proxiamte said first surface causes formation of two aligned side cuts along a first side of a register box that is being formed from said sheet of material, a second side opposite said first side, and an opening disposed substantially in a middle of said register box that is being formed from said sheet of material;
positioning said sheet of material proximate said second surface and within said press;
stamping said press onto said sheet of material proximate said second surface;
wherein said stamping proximate said second surface causes formation of a cut extending between said two aligned side cuts so as to complete formation of said first side of said register box, forms a flange about said opening, and bends two portions of said sheet of material at right angles relative to a portion of said sheet of material wherein said opening is located so that each of said first side and said second side having a substantially U-shape;
wherein said flange has a height of about 0.5″;
attaching a first end piece to said first side;
attaching a second end piece to said second side; and
attaching a collar to said flange;
wherein said collar has a height of about 3.5″.

8. The method of claim 7 wherein said first surface and said second surface are aligned with one another, so that said sheet of material may be advanced from said first surface to said second surface by forward movement of said sheet of material.
